(19) United States
(12) Patent Application Publication
(10) Pub. No.: US 2001/0036257 A1
(43) Pub. Date: Nov. 1, 2001

(54) Voice invoked call blocking

(76) Inventor: John McMahon, Orleans (CA)

Correspondence Address: MARKS AND CLERK, P O BOX 957, STATION B, 55 METCALFE STREET, SUITE 1380, OTTAWA, ON, K1P5S7, CA

(21) Appl. No.: 09/799,011

(22) Filed: Mar. 6, 2001

(30) Foreign Application Priority Data
Mar. 7, 2000 (GB) 0005285.2

(51) Int. Cl. H04M 3/00; H04M 1/64

(52) U.S. Cl. 379/196; 379/88.01; 379/210.02

(57) ABSTRACT

A system and method for blocking unwanted telephone calls. The system uses voice recognition as the primary characteristic for blocking as opposed to a simple dial source number block. The system thus allows call blocking from any phone anywhere, since the dialing number is immaterial for the decision to block.

### FIELD OF THE INVENTION

The present invention relates to a telephone call blocking method and more particularly, the present invention relates to a method for blocking telephone calls by voice identification.

### BACKGROUND OF THE INVENTION

Typical call blocking arrangements for blocking unwanted calls are well known. The existing methods, the call is blocked based on the number from which it is dialed. Accordingly, if the person whose number is blocked calls from a different phone number, the call will be processed and the unwanted caller connected to the party not wishing to speak to the caller.

The present invention addresses this limitation in the art and provides a device capable of overcoming the shortcomings in the art.

### SUMMARY OF THE INVENTION

One object of the present invention is to provide an improved telephone call blocking method.

A further objection of one embodiment is to provide a method of blocking an unauthorized user at a first location from connection with a user at a second location, each user being connected over a public network communications system, comprising the steps of:

providing an auto attendant connected to the second location;

providing voice recognition software connected to the auto attendant and a line for receiving incoming calls;

identifying the user at the first location to be connected to the second location with the voice recognition software;

confirming the validity of the user at the first location; and

blocking or permitting connection of the user at the first location with the user at the second location.

Yet another object of one embodiment of the present invention is to provide a method of limiting access of a caller to a call recipient on a public network communications system, comprising the steps of:

providing a local area network connected to the public network communications system, the local area network including a plurality of telephones connected thereto;

providing a server connected to the local area network and the public network communications system, the server including an auto attendant, voice recognition software and a database containing voice information;

identifying a caller by voice with the voice recognition software;

comparing the voice of the caller with the information of the database; and

blocking or passing the caller through to the call recipient.

A still further object of one embodiment of the present invention is to provide a communications system for the public network for limiting access of a caller to a call recipient, comprising:

a local area network connected to the public network, the local area network including a plurality of telephones connected thereto;

a server connected to the local area network and the public network, the server including an auto attendant, voice recognition software and a database containing voice information;

voice recognition software connected to the auto attendant for identifying a caller by voice; and

an information database for comparing the voice of the caller with the information of the database to determine whether access to the call recipient may be granted.

Having thus generally described the invention, reference will now be made to the accompanying drawings, illustrating preferred embodiments.

### BRIEF DESCRIPTION OF THE DRAWINGS

FIG. 1 is a schematic diagram of the overall communications system for use with the present invention;

FIG. 2 is a schematic view of one embodiment of the server of the present invention;

FIG. 3 is a schematic view of the overall operation of one embodiment of the present invention; and

FIG. 4 is chart illustrating the event sequence associated with the present invention.

Similar numerals employed in the text denote similar elements.

### DETAILED DESCRIPTION OF THE PREFERRED EMBODIMENTS

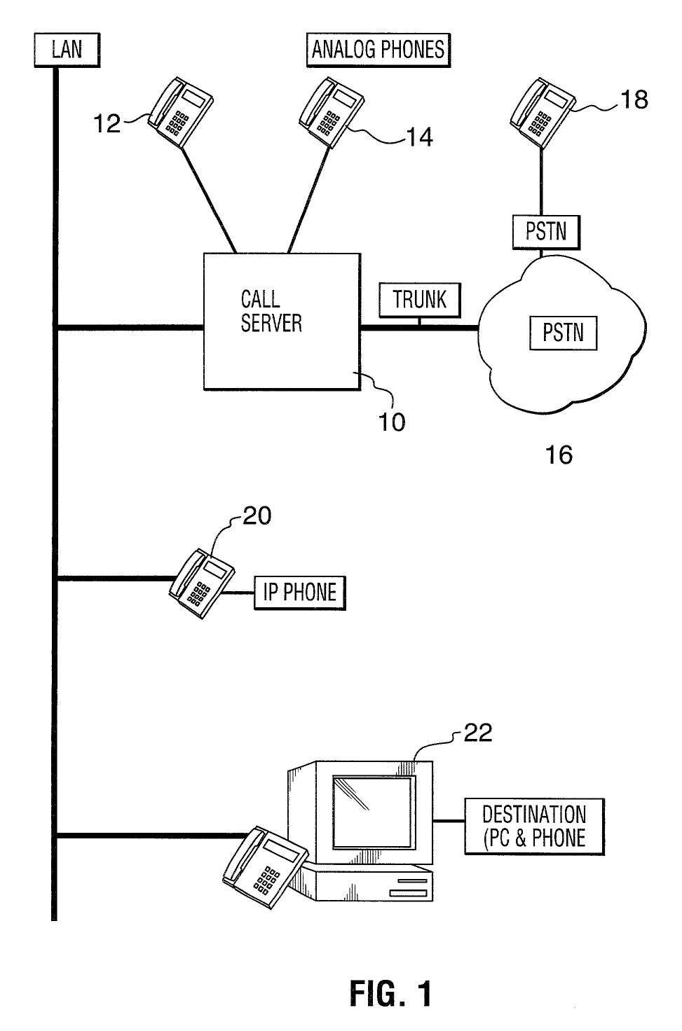

Referring to FIG. 1, shown is a block diagram of one possible arrangement for the phone system to be discussed herein. The known arrangement includes a LAN connecting a call server 10 having analog phoners 12, 14 and a trunk communicating with a public network and representative phone, 16 and 18, respectively. An internet protocol phone 20 and typical PC and phone 22 are also connected to the LAN.

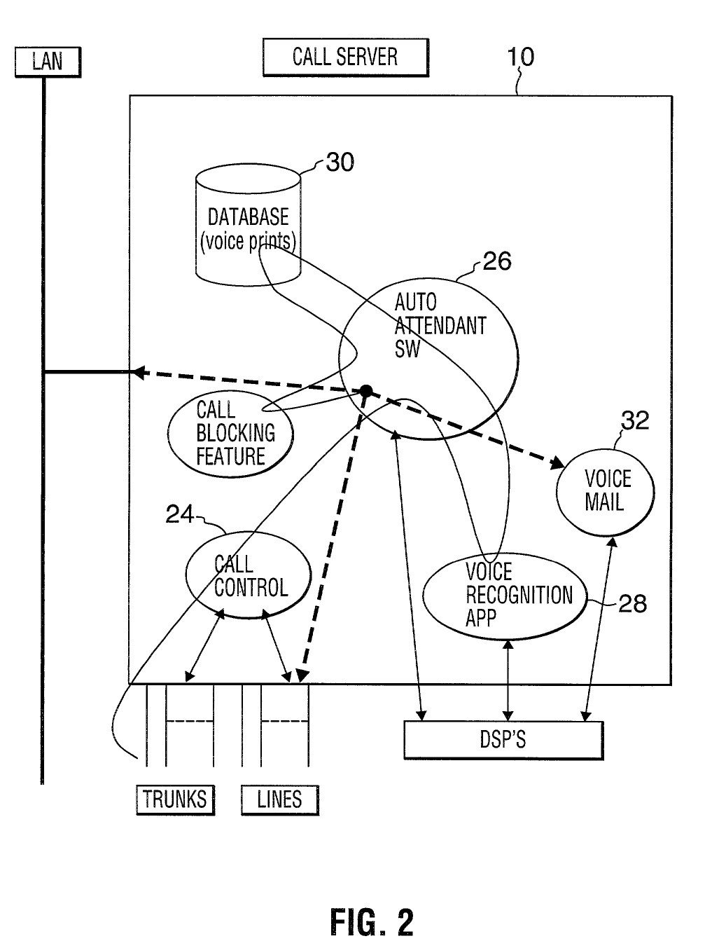

In FIG. 2, the call server 10 is shown in greater detail. The server 10 includes a call controller 24 for directing incoming calls from trunks and from lines. An auto attendant 26 communicates with the call control 24 and with a voice recognition application 28. The voice recognition application analyses the voice patterns by breaking spoken words down into small sections and creates a voice print. The analysis of the spoken word is done by a speech engine which is the foundation of the voice recognition application. All current voice recognition applications use a speech engine. The voice print is then sent back to the auto attendant 26 and subsequently on to a database 30.

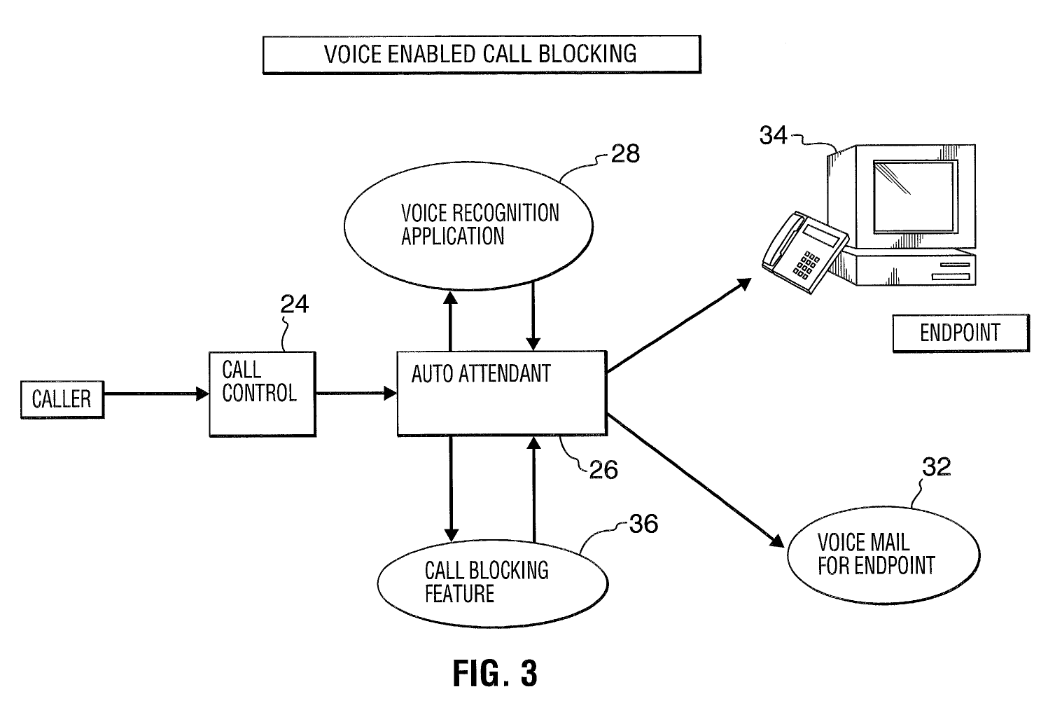

At database 30, a search is conducted with the voice print submitted and the records of the database 30. If the caller user is authorized to proceed based on a successful match of the data and voice print, the call is processed to voice mail 32, the required destination (shown in the example as a PC and phone) 34 or the call is blocked entirely. These features are illustrated in FIG. 3.

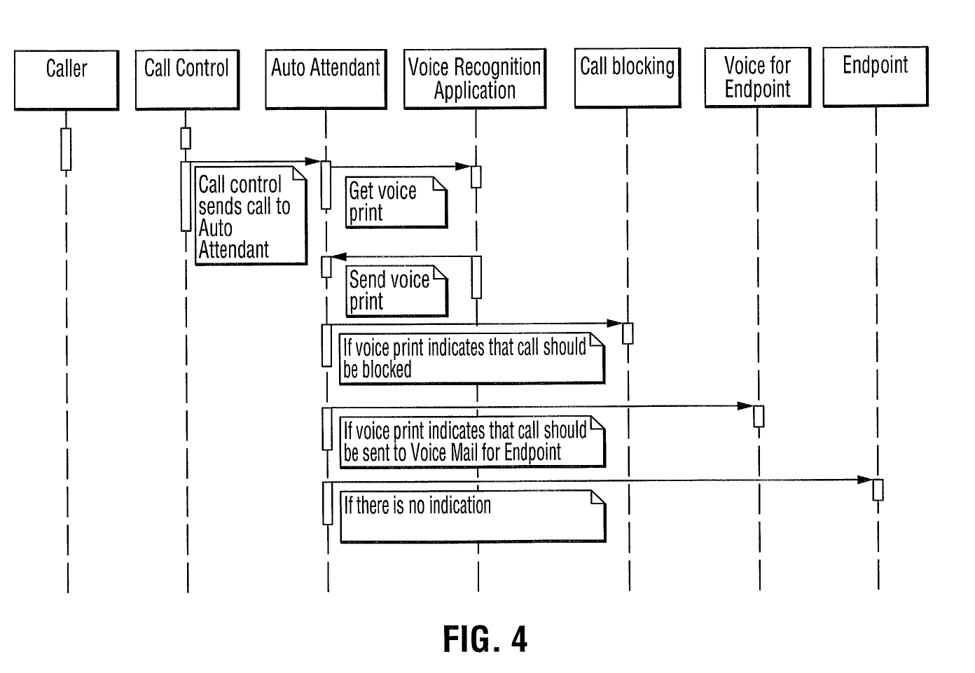

Referring now to FIG. 4, shown is a chart indicating the sequencing associated with the methodology.

Any of the suitable voice recognition speech engines available may be employed and it will be appreciated by those skilled which are useful.

Although embodiments of the invention have been described above, it is not limited thereto and it will be apparent to those skilled in the art that numerous modifications form part of the present invention insofar as they do not depart from the spirit, nature and scope of the claimed and described invention.

1. A method of blocking an unauthorized user at a first location from connection with a user at a second location, each said user being connected over a public network communications system, comprising the steps of:
providing an auto attendant connected to said second location;
providing voice recognition software connected to said auto attendant and a line for receiving incoming calls;
identifying said user at said first location to be connected to said second location with said voice recognition software;
confirming the validity of said user at said first location; and
blocking or permitting connection of said user at said first location with said user at said second location.

2. The method as set forth in claim 1, further including the step of providing a database of voice prints for confirming identification of a user.

3. The method as set forth in claim 1, wherein connection at said second location comprises connection to one of a voice mail site or said user at said second location.

4. A method of limiting access of a caller to a call recipient on a public network communications system, comprising the steps of:
providing a local area network connected to said public network communications system, said local area network including a plurality of telephones connected thereto;
providing a server connected to said local area network and said public network communications system, said server including an auto attendant, voice recognition software and a database containing voice information;
identifying a caller by voice with said voice recognition software;
comparing the voice of said caller with said information of said database; and
blocking or passing said caller through to said call recipient.

5. The method as set forth in claim 4, wherein said call recipient includes of voice mail.

6. The system as set forth in claim 4, wherein said voice information is exchanged with said auto attendant, said database and said voice recognition software.

7. A communications system for the public network for limiting access of a caller to a call recipient, comprising:
a local area network connected to said public network, said local area network including a plurality of telephones connected thereto;
a server connected to said local area network and said public network, said server including an auto attendant, voice recognition software and a database containing voice information;
voice recognition software connected to said auto attendant for identifying a caller by voice; and
an information database for comparing the voice of said caller with said information of said database to determine whether access to said call recipient may be granted.

8. The system as set forth in claim 7, wherein said server includes call control means for controlling incoming calls from trunks and lines.
